(19) United States
(12) Patent Application Publication
(10) Pub. No.: US 2009/0066679 A1
(43) Pub. Date: Mar. 12, 2009

(54) PLASMA DISPLAY DEVICE

(76) Inventors: Yoshikazu Kanazawa, Miyazaki (JP); Takashi Fujisaki, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/298,553

(22) PCT Filed: Jul. 4, 2006
(86) PCT No.: PCT/JP2006/313333

§ 371 Date: Oct. 27, 2008

(51) Int. Cl. G06F 3/038

(52) U.S. Cl. 345/206

(57) ABSTRACT

Provided is a technique relating to a scan driver of a PDP device which is capable of ensuring or improving performances of power consumption and temperature in an arrangement configuration of a substrate and a plurality of ICs, particularly, also in an area including an IC at a second position from the top. A scan driver (122) comprises, for example, two substrates (20) at the top and bottom that mount a plurality of ICs (30) having a plurality of outputs and are connected to terminals (40) of a Y electrode. Part of the plurality of ICs (30) on the substrate (20) has some outputs of the plurality of outputs are not connected to the terminals of the Y electrodes, and one (#2) of the ICs is arranged at a second position from the top in a device arrangement configuration.

### TECHNICAL FIELD

The present invention relates to a technique for a plasma display panel (PDP) and a display device (plasma display device: PDP device) of the same, and more particularly, the present invention relates to a mounting configuration of a driving circuit (driver).

### BACKGROUND ART

PDP device has been expected as a display device capable of realizing full-color and large-screen display because of superiority of the display area, display capacity, and further, responsivity. Currently, as direct-view-type display devices, large screens of 40 inches to 60 inches, which cannot be realized by other devices, have been realized.

In a conventional PDP device, a scan driver for scanning driving of scan electrodes (Y electrodes) is integrated in a unit of, for example, 64-bit output as a driver, and the scan driver comprises a plurality of ICs (scan driver ICs) on a substrate (scan driver substrate). In the case of a large-screen PDP device of 40 inches to 60 inches, generally, the scan driver is mounted on two scan-driver substrates, upper one and lower one, and IC groups separately.

As a configuration example of connections of a driver of a PDP, ICs (driver ICs) thereof, and PDP electrode terminals, there is a case in which part of the outputs of the top IC among the plurality of ICs is unused (in other words, not connected to the PDP electrode terminals) so as to reduce the power consumption of the IC and reduce the temperature of the IC at the upper position in the device arrangement (see FIG. 11 described later). For example, when the total number of the Y electrodes and the sum of the number of output bits of the plurality of scan driver ICs do not match, part of the outputs of the ICs is unused. Such a conventional technique example is described in Japanese Patent Application Laid-Open Publication No. 2002-304151 (Patent Document 1). As a configuration example that is relevant and similar to this, there is a configuration example in which an excess caused by a difference between the number of the PDP electrodes and the total number of the IC output bits is allocated to the top and bottom ICs in the device arrangement.

Patent Document 1: Japanese Patent Application Laid-Open Publication No. 2002-304151

### DISCLOSURE OF THE INVENTION

In the case of the circuit mounting configuration of drivers such as the scan driver in the abovedescribed conventional PDP device, in a general device arrangement, among the plurality of ICs (driver ICs), a first (at-the-head) IC side is positioned on the upper side (higher side) in the PDP device, and the last IC side is positioned on the lower side (low) in the PDP device. Since the ICs generate heat in accordance with power consumption, a device design that takes the temperature and heat dissipation into consideration is required. The factors of the temperature of the IC include, for example, in addition to the self heating of the IC, influence of adjacent ICs and influence of the temperature increase in the PDP device. A temperature of the lower ICs is increased mainly by the self heating of the ICs per se; however, the upper ICs are under harsher conditions in terms of temperature due to influence of heat generation of adjacent ICs in the lower side and influence of the fact that the temperature of the upper side becomes generally higher in the PDP device.

In the abovedescribed general configuration of the scan driver, among the plurality of ICs, in the IC group of the upper side, particularly, the IC at the second position from the top is most largely affected by the influence about the temperature and has a highest temperature among all the ICs. For example, in the conventional technique example of FIG. 11, as compared with a second IC (#2), a first (top) IC (#1) is advantageous in terms of temperature than the second IC (#2) since it does not have an adjacent IC in the upper side and the influence of heat generation from an adjacent IC is only from the lower side. Therefore, the temperature of the second IC (#2) is the highest. Thus, in the general configuration of the driver of the conventional PDP device, particularly, in the conventional technique example like FIG. 11, effects in terms of performance of, for example, the temperature cannot be expected so much in some cases.

In addition, electrically equivalent ICs are mounted as the individual ICs in the driver; however, since the second IC (#2) particularly has the highest temperature, a countermeasure for heat dissipation, for example, separately adding a heat sink to the scan driver substrate, has been needed.

The present invention has been made in view of the abovedescribed problems, and an object thereof is to provide a technique in relation to a circuit mounting configuration of drivers such as a scan driver (Y-electrode driving unit) in a PDP device, capable of ensuring or improving performances of power consumption and temperature in the arrangement configuration of the substrates and the plurality of ICs, particularly, also in a region including an IC at a second position from the top.

The typical ones of the inventions disclosed in this application will be briefly described as follows. To achieve the abovesaid object, the present invention is a technique of a PDP device comprising a PDP and a circuit unit for driving and controlling the PDP, and a feature of the present invention is to comprise technical means described below.

(1) In a PDP device of the present invention, a circuit mounting configuration of a Y-electrode driving unit such as a scan driver is configured so that at least a scan driver IC disposed at a second position from the top (second IC) is configured to use merely a part of output bits thereof (connected to terminals of Y electrodes) instead of using all of the output bits. In this manner, power consumption per one IC is reduced, and reduction of temperature in a region including the second IC is realized.

(2) When the scan drivers are formed separately by a plurality of substrates (at least two substrates on the upper side and lower side) on which a plurality of ICs are loaded, the upper substrate is configured to be larger than the lower substrate, in other words, the area and the like per an IC is larger. Alternatively, the configuration is made to have a mounting spacing among the ICs loaded on the substrate being wider in the upper substrate compared with the lower substrate. According to these points, reduction of temperature of the region including the second IC is realized.

The present PDP device has, for example, a configuration described below. The PDP comprises at least a Y electrode group used in scan driving. The PDP device has a first circuit (Y-electrode drive unit) having a function of individually scanning/driving the Y-electrode group. The PDP comprises, for example, on a front substrate, a first-electrode (Y-electrode) group having a function of scan (scanning) and sustain (sustaining). Either one of the front and back substrates may comprise a second-electrode (X-electrode) group having a function of sustaining. Furthermore, either one of the front and back substrates may have a third-electrode (address-electrode) group having a function of addressing or may not have it. The first circuit (Y-electrode driving unit) has, for example, a Y driving circuit (Y sustain driver) for commonly driving, for example, like sustain driving the Y-electrode group, and a scan driving circuit (scan driver) for driving scanning of the Y-electrode group, respectively.

The scan driver applies scan pulses to the first electrodes, individually, and sequentially applies the scan pulses to the Y-electrode group. The scan driver comprises one or more substrates (IC substrates) on which a plurality of ICs (semiconductor integrated circuit devices/IC chips) having a plurality of outputs (output terminals) are mounted. Outputs to be used of the ICs are connected to the Y electrodes (terminals thereof). Among the plurality of ICs on the substrate, in part (at least one or more) of the ICs (first-type ICs), part of the outputs among the plurality of outputs of the ICs is not connected to the Y electrode group (terminals thereof) and is unused. The first-type IC having the unused outputs is disposed at a second position from the top in the device arrangement configuration.

The effects obtained by typical aspects of the present invention will be briefly described below. According to the present invention, in relation to a circuit mounting configuration of drivers such as a scan driver (Y-electrode driving unit) in a PDP device, performances of power consumption and temperature can be ensured or improved in the arrangement configuration of the substrates and the plurality of ICs, particularly, also in a region including an IC at a second position from the top.

### BRIEF DESCRIPTIONS OF THE DRAWINGS

FIG. 1 is a diagram showing a schematic configuration of the entirety of a PDP device according to an embodiment of the present invention;

FIG. 2 is a diagram showing a configuration of electrodes of a PDP in the PDP device according to the embodiment of the present invention;

FIG. 3 is a diagram showing a basic configuration of a Y-electrode driving unit including a scan driver in the PDP device according to the embodiment of the present invention;

FIG. 4 is a diagram showing a circuit mounting configuration and a configuration of IC output wirings of a scan driver in the PDP device according to a first embodiment of the present invention;

FIG. 5 is a diagram showing a configuration of an operation of scan driving of the scan driver in the PDP device according to the first embodiment of the present invention;

FIG. 6 is a diagram showing a circuit mounting configuration and a configuration of IC output wirings of a scan driver in a PDP device according to a second embodiment of the present invention;

FIG. 7 is a diagram showing a circuit mounting configuration and a configuration of IC output wirings of a scan driver in a PDP device according to a third embodiment of the present invention;

FIG. 8 is a diagram showing a configuration of an operation of scan driving of the scan driver in the PDP device according to the third embodiment of the present invention;

FIG. 9 is a diagram showing a circuit mounting configuration and a configuration of IC output wirings of a scan driver in a PDP device according to a fourth embodiment of the present invention;

FIG. 10 is a diagram showing a circuit mounting configuration and a configuration of IC output wirings of a scan driver in a PDP device according to a fifth embodiment of the present invention; and

FIG. 11 is a diagram showing a circuit mounting configuration and a configuration of IC output wirings of a scan driver in a PDP device according to a conventional technique example.

### BEST MODE FOR CARRYING OUT THE INVENTION

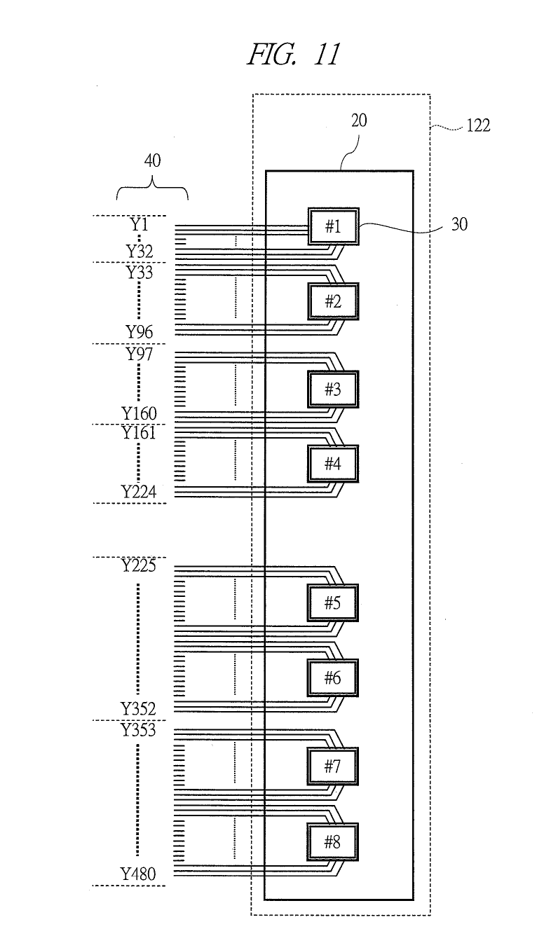

Hereinafter, embodiments of the present invention will be described in detail with reference to the accompanying drawings. Note that, components having the same function are denoted by the same reference symbols throughout the drawings for describing the embodiment, and the repetitive description thereof will be omitted. Note that, FIG. 11 shows an example of a conventional technique for giving a comprehensible explanation in comparison with the present invention.

<PDP Device>

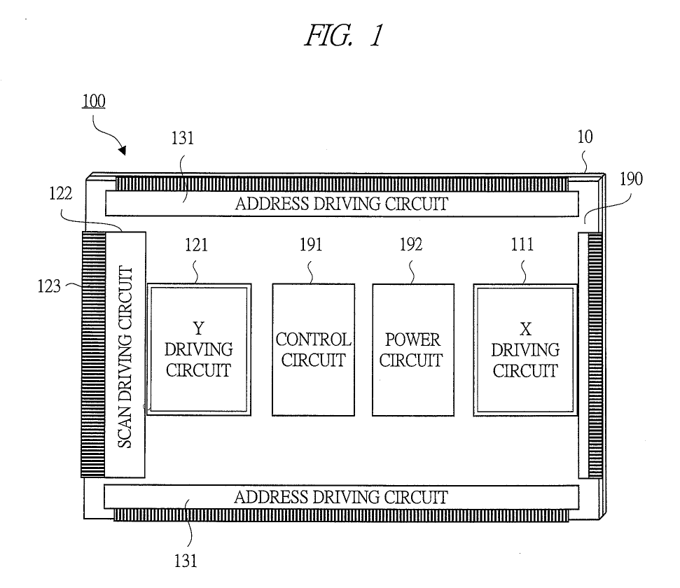

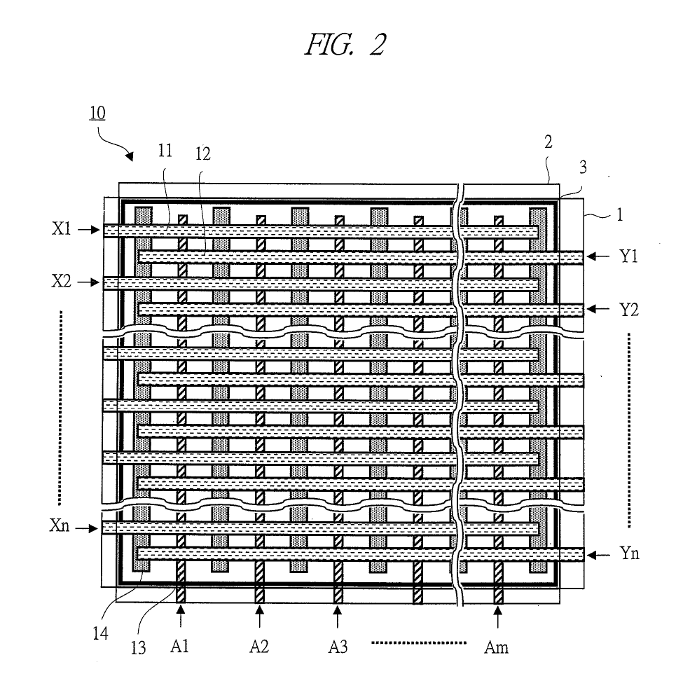

First, in FIG. 1 and FIG. 2, a basic configuration of a PDP device of the present embodiment will be described.

In FIG. 1, the present PDP device (PDP module) 100 mainly comprises a PDP 10 and a chassis 190 holding the PDP 10 and having formed thereto circuit units, etc. The circuit units mainly include: an X-driving circuit (X sustain driver) 111 which drives X electrodes (sustain electrodes) 11; a Y-driving circuit (Y sustain driver) 121 and a scan driving circuit (scan driver) 122 which drive Y electrodes (sustain/scan electrodes) 12; driving circuits including an address driving circuit (address driver) which drives address electrodes 13; a control circuit 191 which controls the driving circuits, etc.; and a power supply circuit 192 which supplies power to the circuits, and so on.

In FIG. 2, the PDP 10 has a structure in which a discharge gap sandwiched by a structure that comprises two front and rear glass substrates (front plate 1 and rear plate 2) on which groups of the electrodes (11, 12, 13) are formed is filled with a mixture gas of Ne, Xe, etc. for discharges, and sealed by a sealing part 3. In this structure, a discharge is generated by applying a voltage that is larger than or equal to a discharge starting voltage (firing voltage) between the electrodes, and ultraviolet rays generated by the discharge excite phosphors formed on the substrate and cause the phosphors to emit light, thereby performing display.

The PDP 10 mainly comprises, in a three-electrode structure, the X electrode (sustain electrode) 11, the Y electrode (sustain/scan electrode) 12, and the address electrode 13. A row is formed by a set of the X electrode 11 and the Y electrode 12 extending in a first (horizontal) direction; furthermore, a display cell is formed to corresponding to the region that is intersecting with the address electrode 13, which is extending in a second (vertical) direction and divided by barrier ribs 14. Various types of the structure of the PDP 10 exist depending on the drive methods.

The plurality of Y electrodes 12 {Y1 to Yn} are subjected to sustain driving by the Y-driving circuit 121 and subjected to scan driving by the scan driving circuit 122. The number (n) of the lines of the Y electrodes 12 is, for example, 480 lines and 512 lines.

<Y-Electrode Driving Unit>

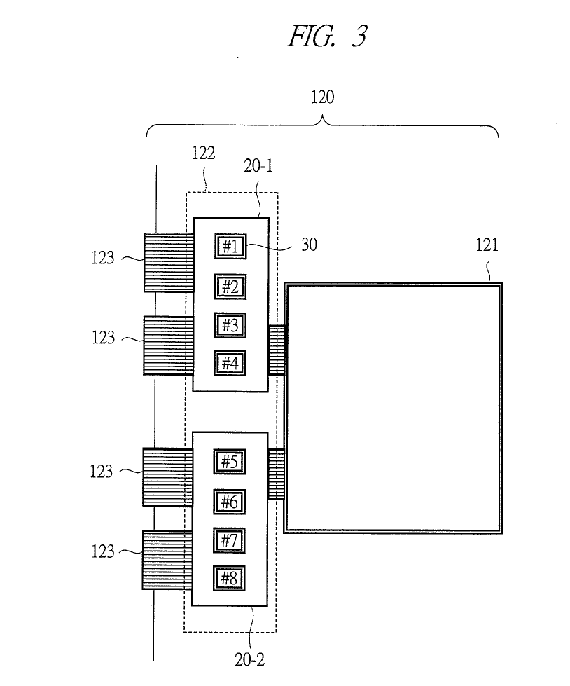

FIG. 3 shows a configuration of a Y electrode driving unit 120 which is a basic premised technique. The Y-electrode drive unit 120 has a function of applying a scan pulse (scan driving waveform) to the plurality of Y electrodes 12 of the PDP 10, respectively. The Y-electrode driving unit 120 comprises the Y driving circuit (Y sustain driver) 121, the scan driving circuit (scan driver) 122, etc.

The Y driving circuit 121 generates the pulses which are to be commonly applied to all the Y electrodes 12 such as a sustain pulse applied in a sustain period and a reset pulse applied in a reset period in subfield driving control, and applies them to the Y electrodes 12 via the scan driver 122.

On the other hand, the scan driver 122 applies scan pulses to the respective Y electrodes 12 as a scanning operation in an address period in the subfield driving control. The scan driver 122 has circuits corresponding to the number (n) of the Y electrodes 12 of the PDP 10.

Generally, the scan driver 122 is integrated in a unit of, for example, 64-bit output and is composed of a plurality of ICs (scan driver ICs) 30 on substrates 20. Therefore, for example, in the case where the PDP 10 having 512 lines of Y electrodes 12, eight ICs 30 each of which having 64-bit output are used in total (64×8=512) in the scan driver 122. The individual ICs 30 electrically have same functions and loads, mutually.

The outputs from the ICs 30 of the scan driver 122 are electrically connected to the Y electrodes 12 (particularly, terminals 40 thereof) of the PDP 10 via a connection part comprising FPCBs (flexible printed circuit boards/flexible cables) 123, etc. Each FPCB 123 is disposed in a curve bending towards the terminals 40 in the PDP 10 side.

For example, for large-screen PDP devices of 40 inches to 60 inches, generally, the scan driver 122 and the group of the ICs 30 thereof are mounted separately on two substrates (scan driver substrates) 20 on the upper side and lower side. In FIG. 3, the scan driver 122 is formed separately on an upper first substrate 20-1 and a lower second substrate 20-2. Note that, the wording “upper and lower” referred herein means the “upper” side and “lower” side in the vertical direction in a state where the PDP device 100 and a screen of the PDP 10 are normally perpendicularly installed. Conventionally, when the scan driver 122 comprises two of the substrates 20, the upper and lower ones are generally designed to be symmetrical (same configurations in the top and bottom). For example, in FIG. 3, four equivalent ICs 20 are mounted on each of upper and lower substrates 20-1 and 20-2. In the scan driver 122 of the present embodiment, in order to devise the configuration of the upper substrate 20-1, the top and bottom have asymmetrical configurations.

### EXAMPLE OF CONVENTIONAL TECHNIQUE

Next, an example of a conventional technique with regard to the scan driver 122 will be described for comparison. In FIG. 11, particularly, a configuration example of output wirings (connections of the ICs 30 of the scan driver 122 and the terminals 40 of the PDP 10 side) is shown as a conventional configuration example of the scan driver 122. A circuit configuration of the case in which, for example, eight ICs 30, each of which having 64-bit output, (first IC (#1) to eighth IC (#8)) are used with respect to, for example, the PDP 10 having 480 lines of the terminals (panel terminals, represented by Y) 40 of the Y electrodes 12 is shown. In this configuration example, among the plurality of ICs 30, part of the outputs (1st output to 32nd output) of the top IC 30 (IC#1) are unused (not connected) so as to reduce power consumption and temperature.

As the outputs (output terminals) of the ICs 30, in total, 512 bits of the eight ICs 30 are present (64×8=512). The part corresponding to 32 bits is excess in the 512-bit outputs with respect to the 480 lines of the terminals 40 of the Y electrodes 12. Regarding the excess 32 bits caused by the difference between the number of the terminals 40 of the Y electrodes 12 and the total number of the output bits of all the ICs 30, the part corresponding to 32 bits (1st output to 32nd output) from the top bit of the first IC (#1) 30 at the top in the device arrangement is not connected to the terminals 40 of the Y electrodes 12, and the 33rd bit (33rd output) and the following part are connected in the configuration. In other words, the outputs (33rd output to 64th output) corresponding to the second-half 32 bits of the first IC (#1) 30 are connected to the 1st to 32nd terminals 40 (Y1 to Y32) of the Y electrodes 12. The 64-bit outputs of each of the ICs 30 of the second IC (#2) 30 and those subsequent thereto are sequentially connected to the terminals 40 (Y33 to Y480) of the 33rd Y electrode 12 and those subsequent thereto.

By virtue of the abovedescribed configuration, the power consumption of the first IC (#1) 30 having the unused outputs is reduced, thereby reducing the temperature of the IC 30 (IC #1) at an upper position in the device arrangement. Such a technique is disclosed in the abovementioned Patent Document 1. There is also another configuration example in which, in the case where the Y electrodes 12 have 480 lines, the part corresponding to the excess 32 bits caused by the difference between the number of the terminals 40 and the total number of the output bits of all the ICs 30 is separately allocated to the top and the bottom ICs (for example, IC #1 and IC #8) in the device arrangement, so that, at each of the ICs, the outputs corresponding to 16 bits are not connected to the terminals 40.

### First Embodiment

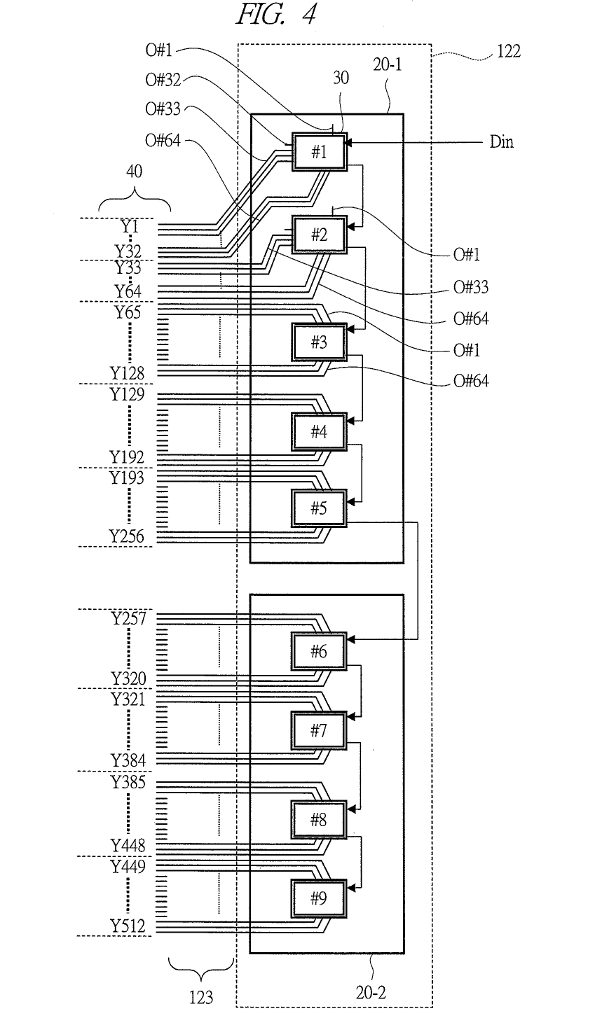

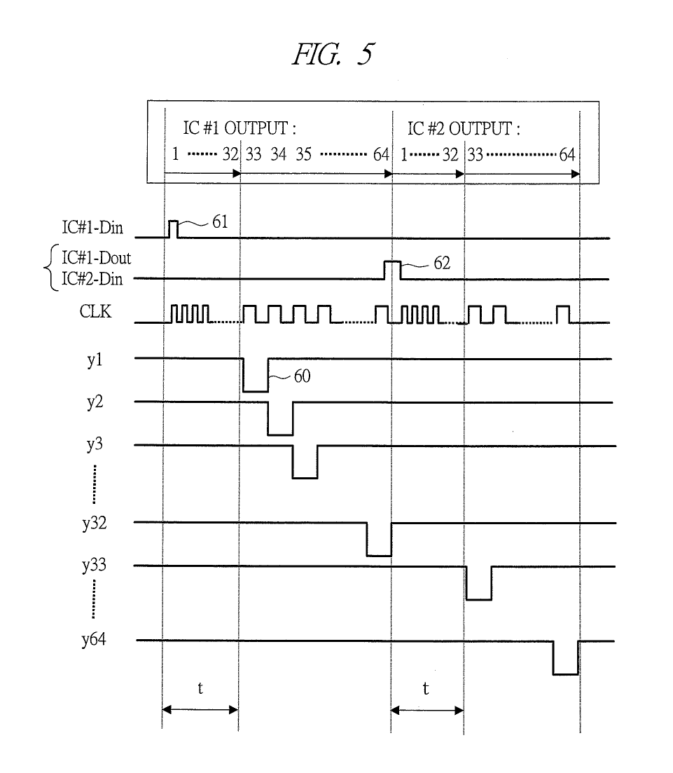

Next, a first embodiment of the present invention will be described with reference to FIG. 4 to FIG. 5. In a PDP device 100 of the first embodiment, the number of used outputs of the IC 30 (IC #2) disposed at a second position from the top is mainly reduced, thereby reducing power consumption and temperature.

In FIG. 4, a configuration of the scan driver 122 in the first embodiment will be described. The scan driver 122 is formed separately by the upper and lower two substrates 20-1 and 20-2. Five ICs 30 (IC #1 to IC #5) are mounted on the upper first substrate 20-1. Meanwhile, four ICs 30 (IC #6 to IC #9) are mounted on the lower second substrate 20-2. Each of all the ICs 30 has 64-bit outputs and is electrically equivalent to each other. On the other hand, the Y electrodes 12 of the PDP 10 have 512 lines and have the corresponding number of the terminals 40 (Y1 to Y512). The outputs (output terminals: represented by O#) of the ICs 30 are connected to the terminals 40 of the Y electrodes 12 of the PDP 10 side via the FPCB 123, etc.

Din (data input) which is an input to the first IC (#1) 30 is an input of data from the Y-driving circuit 121. The data is, for example, the data for determining timing of outputting scan pulses from the scan driver 122 to the Y electrodes 12. The plurality of ICs 30 are serially connected in the line of data input/output so that the last data output of the first IC 30 serves as the data input of the second IC 30.

In each of the top first IC #1 and the second IC #2 which is at a second position from the top on the first substrate 20-1, 32 bits, which are half of the 64-bit outputs, are used (connected to the terminals 40). In each of the other ICs (#3 to #9) 30, all the 64-bit outputs are used. In the first IC (#1) 30, a first output (O#1) to a 32nd output (O#32) corresponding to the first-half 32 bits are not connected to the terminals 40 of the Y electrode 12, and a 33rd output (O#33) to a 64th output (O#64) corresponding to the second-half 32 bits are connected to the 1st to 32nd terminals 40 (Y1 to Y32). In the second IC (#2) 30, similarly, the 1st output (O#1) to 32nd output (O#32) corresponding to the first-half 32 bits are not connected to the terminals 40 of the Y electrodes 12, and the 33rd output (O#33) to 64th output (O#64) corresponding to the second-half 32 bits are connected to the terminals 40 (Y33 to Y64) of the 33rd to 64th terminals. With respect to the 65th and the subsequent terminals 40 (Y65 to Y512), the outputs of the third IC (#3) 30 and those subsequent thereto are sequentially connected.

A fact that the second IC (#2) 30 and subsequently the adjacent ICs (#1, #3) 30 are under thermally harsh conditions in the vertical arrangement of the plurality of ICs 30 is taken into consideration. Therefore, in the first embodiment, first, in the second IC (#2) 30, half (O#1 to O#32) of all the outputs (O#1 to O#64) are unused, and the other half (O#33 to O#64) is used. At the same time, in the adjacent first IC (#1) 30, half (O#33 to O#64) of the outputs are used.

For a similar consideration, another embodiment can employ a configuration in which all the outputs (#1 to O#64) are used in the first IC (#1) 30, and half the outputs are used both in the second IC (#2) 30 and the third IC (#3).

The operation of the circuit of the scan driver 122 of the first embodiment will be described according to the waveforms of FIG. 5. From the top, a waveform 61 of “IC#1-Din” is a data input (Din) of the first IC (#1) 30. A waveform 62 of “IC#1-Dout, IC#2-Din” is a last data output of the first IC (#1) 30 and, at the same time, a data input of the next second IC (#2) 30. “CLK” is a control clock. “y1” to “y64” are waveforms input from the output side of the ICs 30 to the terminals 40 of the Y electrodes 12, where scan pulses 60 are sequentially input to the terminals 40, respectively. On the top, a correspondence relation of the IC #1 outputs (O#) {1, . . . , 64} and the IC #2 outputs (O#) {1, . . . , 64} is shown.

In order to output the scan pulse 60 to the Y1 electrode which is the first Y electrode 12 from the top in the PDP 10, first, empty data (data of Din) is sent in the outputs (O#1 to O#32) corresponding to the top 32 bits, which are unused outputs of the first IC (#1) 30, as shown in an empty data sending period t, and the scan pulse 60 for the Y1 electrode is output from the output (O#33) of the 33rd bit, which is in the second half of the first IC (#1). Consequently, the scan pulses 60 are sequentially applied from the Y1 electrode to the Y32 electrode. Next, similarly in the second IC (#2) 30, the part corresponding to the first-half 32 bits (O#1 to O#32) is unused, and, after empty data is sent in a period t, the scan pulses 60 for the Y33 electrode to the Y64 electrode are sequentially output from the 33rd-bit output (O#33) of the second IC #2.

According to the first embodiment, particularly, by virtue of the configuration in which the second IC (#2) 30 which is the IC at the second position from the top where the condition in terms of temperature become the harshest conventionally is provided with the unused outputs, the power consumption of the second IC (#2) 30 is reduced, thereby reducing the temperature of the region in the vicinity of the second IC (#2) 30. Therefore, a temperature distribution among the plurality of ICs 30 is well balanced, and satisfactory performance in terms of temperature can be ensured or improved even if a heatsink is not added to the configuration.

### Second Embodiment

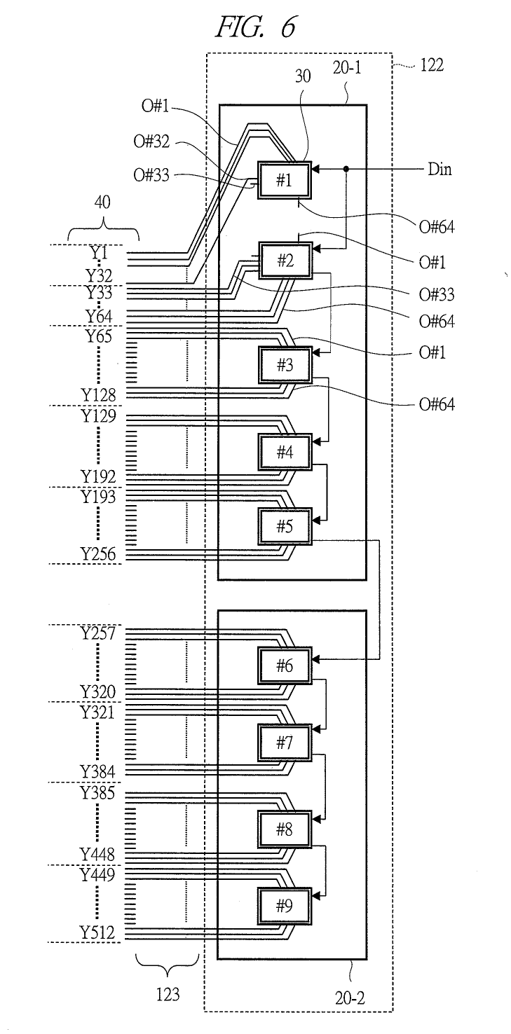

Next, a second embodiment of the present invention will be described with reference to FIG. 6. The second embodiment has a configuration in which, as well as the first embodiment, the second IC (#2) 30 and the first IC (#1) 30 are provided with unused outputs, and the empty data sending period (t) in driving is reduced.

In FIG. 6, the scan driver 122 in the second embodiment is described. In the configuration of the second embodiment, the first IC (#1) 30 and the second IC (#2) 30 have opposite (not duplicated but distributed) configurations in terms of whether the output group (O#1 to O#64) is used (connected with the terminals 40) or not. In other words, the outputs (O#1 to O#32) used in the first IC (#1) 30 are unused outputs in the second IC (#2) 30, oppositely, the outputs (O#33 to O#64) unused in the first IC (#1) are used outputs in the second IC (#2) 30. In this case, the configuration is operated by simultaneously (inphase) inputting the same data as Din to the first IC (#1) 30 and the second IC (#2) 30. By virtue of the abovedescribed configuration, a plurality of scan pulses are continuously applied; thus the empty data sending period (t) as shown in FIG. 5 becomes unnecessary, and the driving time is shortened.

### Third Embodiment

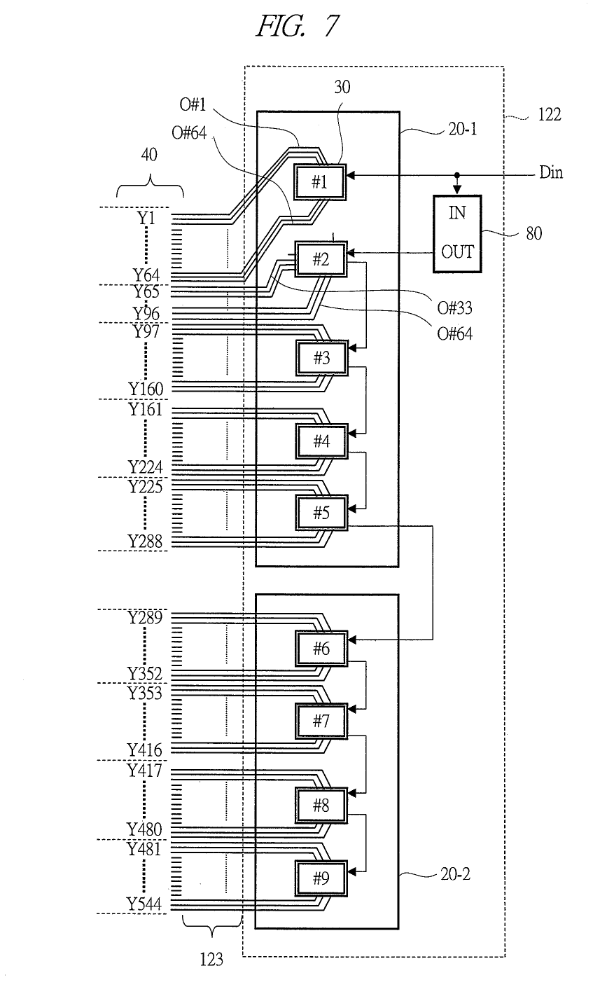

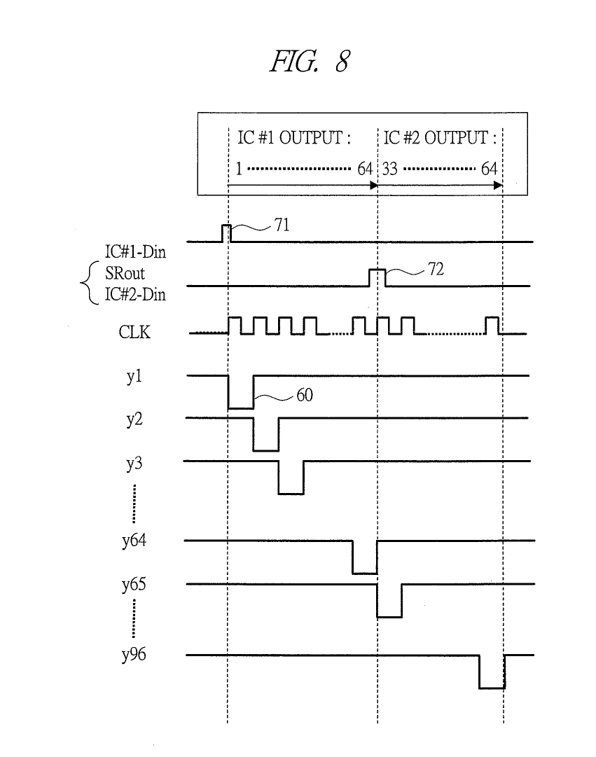

Next, a third embodiment of the present invention will be described with reference to FIG. 7 and FIG. 8. The third embodiment has a configuration in which, similarly to the first embodiment, the second IC (#2) 30 is provided with unused outputs, and the empty data sending period (t) in driving is reduced.

In FIG. 7, the scan driver 122 of the third embodiment will be described. In the configuration of the third embodiment, in order to reduce the empty data sending time (t) that is generated in the case of the first embodiment, a shift register 80 is provided outside the IC 30, specifically, at a preceding stage of the data input part thereof. As the shift register 80, a shift register same as the shift registers incorporated in the IC 30, in this example, a 32-bit shift register is provided. The unused outputs of the second IC (#2) 30 are the first-half 32 bits (O#1 to O#32). Meanwhile, the first IC (#1) 30 uses all the outputs (O#1 to O#64). The used outputs (O#33 to O#64) of the second-half 32 bits of the second IC (#2) 30 are connected to the 65th to 96th terminals 40 (Y65 to Y96) of the Y electrodes 12.

As the configuration of the IC 30, the shift register (for example, one or more 64-bit shift registers) incorporated in the IC 30 is a publicly known technique. In the second IC (#2) 30 and those subsequent thereto, the serial output (last data output: Dout) of the incorporated shift register of each IC 30 is connected to the serial input (data input: Din) of the incorporated shift register of the IC 30 at the next position. The data input (Din) from the Y-driving circuit 121 is input to the data input part of the first IC (#1) 30 without change, and Din undergone 32-bit shift in the shift register 80 is input to the data input part of the second IC (#2).

The operation of the circuit of the scan driver 122 of the third embodiment will be described according to the waveforms of FIG. 8. A waveform 71 of “IC#1-Din” is the data input (Din) of the first IC (#1) 30 similar to the first embodiment. A waveform 72 of “SRout, IC#2-Din” is the output of the data of Din that has undergone 32-bit shift in the shift register 80 and, at the same time, the data input of the second IC (#2) 30. “y1” to “y96” are, similar to the above description, waveforms input from the output side of the ICs 30 to the terminals 40 of the Y electrodes 12, where the scan pulses 60 are sequentially input to the terminals 40, respectively. In addition, at the top, a correspondence relation of the IC #1 outputs (O#) {1, . . . , 64} and the IC #2 outputs (O#) {33, . . . , 64} is shown.

In the case of the abovedescribed configuration of FIG. 7, at the point when the output of the scan pulses 60 corresponding to the outputs of the first-half 32 bits is finished among the 64-bit outputs allocated to the first IC (#1) 30, the output (SRout) from the shift register 80 is arranged to be input to the second IC (#2) 30. In other words, the part corresponding to the unused 32 bits in the second IC (#2) 30 is shifted by the shift register 80, thereby delaying the input thereof to the second IC (#2). Consequently, as shown in FIG. 8, between the first IC (#1) 30 and the second IC (#2) 30, the scan pulses 60 are continuously output to the group of the terminals 40 of the Y electrodes 12, and the wasteful time caused by the abovedescribed empty data sending can be reduced.

### Fourth Embodiment

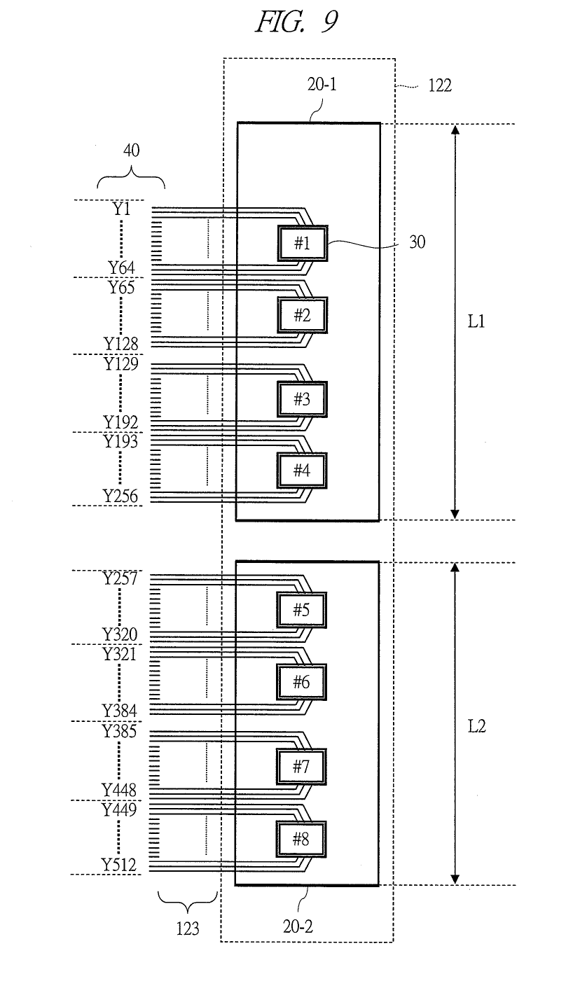

Next, a configuration of the scan driver 122 of a fourth embodiment of the present invention will be described according to FIG. 9. In the fourth embodiment, different from the first embodiment and the like, use/unuse of the outputs of the plurality of ICs 30 is same, and the sizes of the upper and lower substrates 20 are changed, thereby handling heat. The fourth embodiment is an example in which, in the substrates 20 formed separately at the top and the bottom, the size of the upper substrate 20-1 is made larger than that of the lower substrate 20-2.

For example, four equivalent ICs 30 are mounted on each of the upper and lower substrates 20-1 and 20-2, and the connection configuration with the terminal 40 side is same in the upper and the lower sides. A length (L1) of the upper substrate 20-1 in the vertical direction is designed to be longer than a length (L2) of the lower substrate 20-2, and an allowance is provided above the first IC (#1). Thus, heat dissipation or the like from the ICs 30 can be advantageously made in the upper substrate 20-1 compared with the lower substrate 20-2.

According to the fourth embodiment, at the ICs 30 of the upper substrate 20-1 including the second IC (#2) 30, temperature can be reduced more than conventional cases, and satisfactory performance in terms of temperature can be ensured or improved even if a heatsink is not added to the configuration.

### Fifth Embodiment

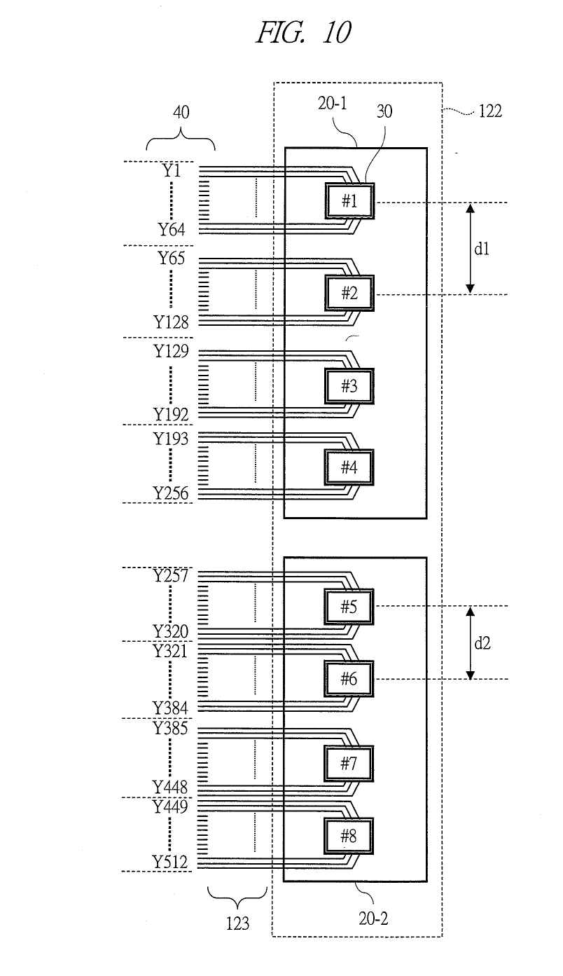

Next, a configuration of the scan driver 122 of a fifth embodiment of the present invention will be described according to FIG. 10. In the fifth embodiment, similar to the fourth embodiment and different from the first embodiment and the like, the use/unuse of the outputs of the plurality of the ICs 30 is same, and heat is dealt by changing the arrangements of the ICs 30 in the upper and lower substrates 20. The fifth embodiment is an example in which a distance (d1) between the ICs 30 disposed on the upper substrate 20-1 is made to be wider than a distance (d2) between the ICs 30 on the lower substrate 20-2. Consequently, in the upper substrate 20-1, heat dissipation or the like from the ICs 30 is advantageously made compared with the lower substrate 20-2, and similar effects as the fourth embodiment can be obtained.

Further, in order to more effectively make the reduction of temperature of the ICs 30 of the scan driver 122, combined configurations of the first to third embodiments with the fourth or fifth embodiment may be employed.

The configurations of the foregoing embodiments are the configurations capable of realizing temperature reduction without the need of adding another heat dissipation means such as a heatsink; however, configurations combined therewith can be employed.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention is applicable to a display device having a circuit of a driver using an IC substrate.

1. A plasma display device comprising:
a plasma display panel having a first electrode group used in scan driving; and
a first circuit for driving the first electrode group, wherein
the first circuit includes a scan driver for applying a scan pulse to the first electrode group, respectively,
the scan driver comprises one or more substrates on which a plurality of ICs are loaded, each IC having a plurality of outputs connected to terminals of the first electrode group,
part of outputs among the plurality of outputs of the IC of a first type, which is part of the plurality of ICs on the substrate is not connected to the terminals of the first electrode group, and
one of the ICs of the first type is disposed at a second position from the top in a device arrangement configuration.

2. The plasma display device according to claim 1, wherein
the scan driver comprises at least two substrates, upper one and lower one, on which the ICs having the plurality of outputs connected to the terminals of the first electrode group are loaded, and
the group of the ICs of the upper substrate has a smaller rate of the outputs of the ICs connected to the first electrode group than the group of the ICs of the lower substrate.

3. The plasma display device according to claim 1, wherein
the scan driver comprises at least two substrates, upper one and lower one, on which the plurality of ICs having the plurality of outputs connected to the terminals of the first electrode group are loaded,
a number of the connections from the upper substrate to the terminals of the first electrode group and a number of the connections from the lower substrate to the terminals of the first electrode group are the same, and
a number of the ICs of the upper substrate is larger than a number of the ICs of the lower substrate.

4. The plasma display device according to claim 1, wherein
at least two ICs of the first type are present; and
in the two ICs of the first type, the outputs connected to the first electrode group and the outputs not connected to the first electrode group have mutually opposite arrangements, wherein the ICs are operated by simultaneously inputting data for determining output timing of the scan pulses.

5. The plasma display device according to claim 1, wherein
each of the ICs in the scan driver is operated so as to output the scan pulses in accordance with input of data which determines output timing of the scan pulses, and the data is shifted by a shift register incorporated in the IC, and data of a last output bit in the IC is input to the IC at a next position, thereby sequentially applying the scan pulses to the first electrode group; and
a first shift register is connected to a preceding stage of a data input part or a subsequent stage of an output part of the IC of the first type, and the first shift register shifts the input or output of the data, thereby continuously applying the scan pulses to the first electrode group.

6. The plasma display device according to claim 5, wherein
a number of bits of the first shift register is same as a number of bits of the outputs of the IC of the first type connected to the first electrode group.

7. A plasma display device comprising:
a plasma display panel having a first electrode group used in scan driving; and
a first circuit for driving the first electrode group, wherein
the first circuit has a scan driver for applying a scan pulse to the first electrode group, respectively,
the scan driver comprises at least two substrates, upper one and lower one, on which a plurality of ICs having a plurality of outputs connected to terminals of the first electrode group are loaded, and
the upper substrate is larger than the lower substrate among the at least two substrates.

8. A plasma display device comprising:
a plasma display panel having a first electrode group used in scan driving; and
a first circuit for driving the first electrode group, wherein
the first circuit has a scan driver for applying a scan pulse to the first electrode group, respectively;
the scan driver comprises at least two substrates, upper one and lower one, on which a plurality of ICs having a plurality of outputs connected to terminals of the first electrode group are loaded; and,
among the at least two substrates, in the upper substrate, a distance between the mounted ICs is wider than that in the lower substrate.
